(19) United States
(12) Patent Application Publication
(10) Pub. No.: US 2005/0094163 A1
(43) Pub. Date: May 5, 2005

(54) Printer driver and method of forming user interface

(76) Inventor: Joo-duck Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/978,375

(22) Filed: Nov. 2, 2004

(30) Foreign Application Priority Data
Nov. 5, 2003 (KR) 2003-78097

(51) Int. Cl. G06F 15/00; G06F 3/12

(52) U.S. Cl. 358/1.6; 358/1.13; 713/321

(57) ABSTRACT

A method of forming a user interface using user interface information received from a printer, and a printer driver therefor. The method includes enabling the host device to issue a request for user interface information to the printer, the user interface information including a list of functions supported by the printer, receiving the user interface information from the printer, and forming a user interface using the user interface information received from the printer. Accordingly, it is possible to drive a plurality of printers by installing only one printer driver in a host device and forming a user interface based on user interface information received from each of the printers. Therefore, the user does not need to install as many printer drivers in the host device as there are printers. In addition, printer manufactures do not need to develop different printer drivers for different types of printers that they manufacture.

### CROSS-REFERENCE TO RELATED APPLICATIONS

This application claims the benefit of Korean Patent Application No. 2003-78097, filed on Nov. 5, 2003, in the Korean Intellectual Property Office, the disclosure of which is incorporated herein in its entirety by reference.

### BACKGROUND OF THE INVENTION

1. Field of the Invention

The present general inventive concept relates to a printer driver, and more particularly, to a method of forming a user interface by receiving user interface information from a printer, and a printer driver.

2. Description of the Related Art

In general, a host device needs a printer driver to drive the printer and then print a document formed using the host device. The printer driver converts data formed using an application program of the host device into data that can be interpreted by the printer, and enables the host device to bilaterally communicate with the printer.

An example of a printer capable of bilaterally communicating with a host device is disclosed in International Patent Application Publication No. WO01/98864, entitled “Method and Apparatus for Enhancing Printer to Computer Interface.”

Conventionally, a user has to install a printer driver compatible with a printer in a host device before using the printer. The printer driver includes printer information, which specifies functions supported by the printer, and serves as a user interface, which provides the user the functions of the printer and allows the user to select the functions that the user desires to use. In addition, the printer driver converts a document formed by the user using an application program into data that can be interpreted by the printer, for example, page description language (PDL) data. Therefore, when the user desires to print the document, the printer driver converts the document into the PDL data and then transmits the PDL data to the printer together with printer setting values selected by the user so that the PDL data can be printed out from the printer.

As described above, conventionally, the printer information on the printer desired by the user is provided by a printer driver compatible with the printer. Thus, the printer driver should be installed in the host device in advance. In a case where a plurality of printers are connected to a host device, printer drivers respectively compatible with the plurality of printers, i.e., as many printer drivers as there are printers, should be installed in the host device, which is inconvenient.

### SUMMARY OF THE INVENTION

The present general inventive concept provides a method of forming a user interface using a printer driver, which enables a plurality of printers to be driven by installing a single printer driver.

The present general inventive concept also provides a printer driver, which forms a user interface and is capable of driving a plurality of printers.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of forming a user interface using a printer driver installed in a host device that bilaterally communicates with a printer, the method comprising enabling the host device to issue a request for user interface information to the printer, the user interface information including a list of functions supported by the printer, receiving the user interface information from the printer, and forming a user interface using the user interface information received from the printer.

The foregoing and/or other aspects and advantages of the present general inventive concept may also be achieved by providing a printer driver installed in a host device that bilaterally communicates with a printer, the printer driver comprising a printer data acquisition unit which issues a request for user interface information to the printer and receives the user interface information from the printer, the user interface information including a list of functions supported by the printer, and a user interface manager which forms a user interface using the user interface information received from the printer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a host device including a printer driver according to an embodiment of the present general inventive concept;

FIG. 2 is a block diagram of the printer driver of FIG. 1;

FIG. 3 is a block diagram of a printing system in which a host device interfaces with a printer via a user interface formed using a printer driver according to another embodiment of the present general inventive concept;

FIG. 4 is a diagram of a screen on which an example of the user interface is displayed;

FIG. 5 is a flowchart of a method of forming a user interface according to another embodiment of the present general inventive concept; and

FIG. 6 is a flowchart of a printing method using a printer driver according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

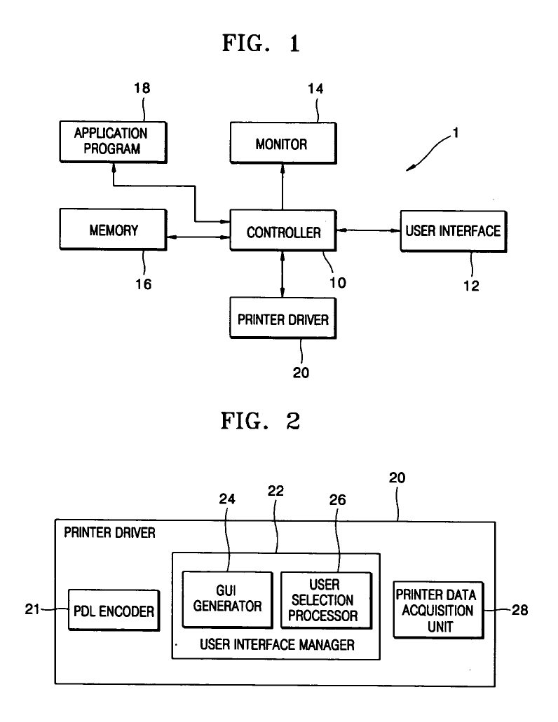

FIG. 1 is a block diagram of a host device 1 including a printer driver 20 according to an embodiment of the present general inventive concept, and FIG. 2 is a block diagram of the printer driver 20 of FIG. 1. Referring to FIGS. 1 and 2, the host device 1 includes a controller 10, a user interface 12, a monitor 14, a memory 16, an application program 18, and the printer driver 20.

The controller 10, which is a so-called central processing unit (CPU), generally controls the host device 1. The user interface 12 displays a list of functions supported by a printer (not shown) on a screen of the monitor 14 so that a user can select the functions that the user desires to use. The memory 16 stores user interface information received from the printer. The application program 18 is used by the user to form a document.

The printer driver 20 includes a page description language (PDL) encoder 21, a user interface manager 22, and a printer data acquisition unit 28. The user interface manager 22 includes a graphic user interface (GUI) generator 24 and a user selection processor 26.

The PDL encoder 21 converts the document formed in the application program 18 into data that can be interpreted by the printer. Since an operation and a function of the PDL encoder 21 are similar to a conventional PDL encoder, detailed descriptions will be omitted. The user interface manager 22 and the printer data acquisition unit 28 are used for receiving the user interface information from the printer and forming the user interface 12.

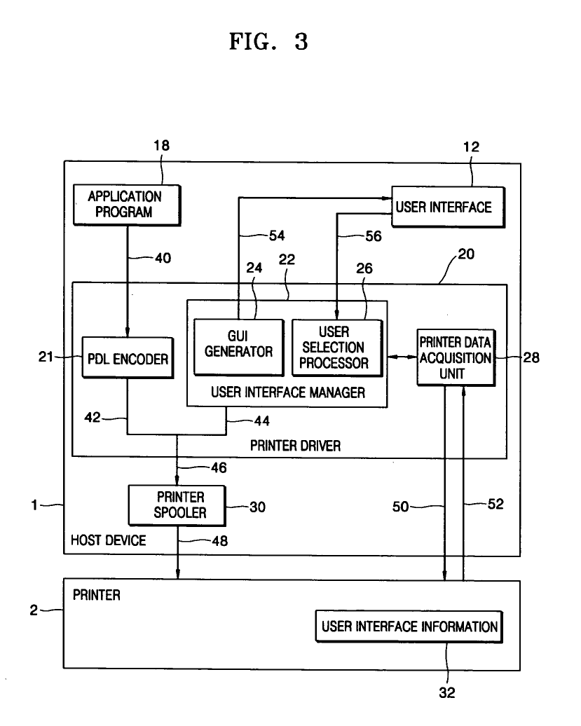

FIG. 3 is a block diagram of a printing system in which a host device 1 interfaces with a printer 2 via a user interface 12 formed using a printer driver 20 according to another embodiment of the present general inventive concept. An interaction between the host device 1 and the printer 2 via the user interface 12 will now be described in further detail with reference to FIGS. 1 through 3.

The host device 1 can bilaterally communicate with the printer 2. The printer driver 20, installed in the host device 1, includes the printer data acquisition unit 28. The printer data acquisition unit 28 issues (outputs) a request for user interface information 32 including a list of functions supported by the printer 2, to the printer 2 through a cable 50 and receives the user interface information 32 from the printer 2 through a cable 52.

The user interface manager 22 forms the user interface 12 using the user interface information 32 received from the printer 2 through a cable 54. The functions supported by the printer 2 include at least one of a function associated with types of printing papers supported by the printer 2 and a function associated with resolutions supported by the printer 2. In addition, the user interface information 32 includes printer control commands 44 respectively associated with the functions supported by the printer 2.

The GUI generator 24 included in the user interface manager 22 forms the user interface 12 in a GUI form using the user interface information 32. Therefore, a user can conveniently select one or more of the functions supported by the printer 2 that the user desires to use.

The user interface information 32 is stored in the memory 16 connected to the printer driver 20. Therefore, when the user selects the printer 2 in order to print a document, the host device 1 can use the user interface information 32 stored in the memory 16 without the need to receive the user interface information 32 again from the printer 2.

The user interface 12, formed in the above-described manner by the user interface manager 22, is displayed on the screen of the monitor 14. Then, the user can select one or more of the functions supported by the printer that the user desires to use via the user interface 12 displayed on a screen of the monitor 14.

If the user selects some of the functions supported by the printer 2 via the user interface 12, the selected functions are transmitted through a cable 56 to the user selection processor 26 and are stored in the memory 16. Therefore, when the user desires to use the selected functions later again, there is no need to select the corresponding functions again because they are already stored in the memory 16.

If the user desires to form a document using the application program 18 connected to the printer driver 20 through a cable 40 and then print the document, the document is converted into PDL data 42 by the PDL encoder 21 of the printer driver 20. The printer control commands 44, respectively corresponding to the selected functions, are transmitted through a cable 46 to a print spooler 30 together with the PDL data 42 and then to the printer 2 through a cable 48. The print spooler 30 temporarily stores the PDL data 42 until the printer 2 is ready to print the PDL data 42.

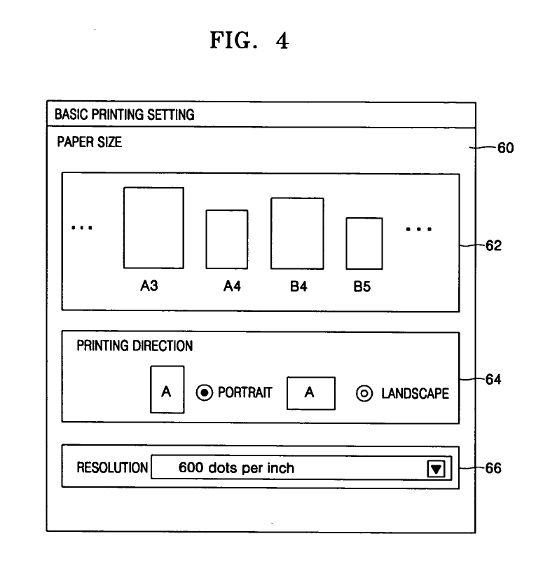

FIG. 4 is a diagram of a screen on which an example of the user interface 12 is displayed. Referring to FIG. 4, a basic printing setting screen 60 includes a printing paper size section 62, which displays various sizes of printing papers supported by the printer 2, for example, A3, A4, B4, and B5, a printing direction section 64 which allows a user to select landscape or portrait printing, and a resolution section 66 which allows the user to select one of resolutions supported by the printer 2 (e.g., 600, 300, 150, and 75 dots per inch).

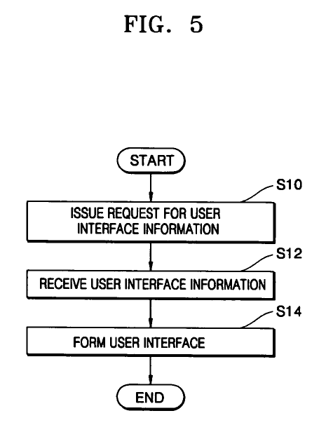

A method of forming a user interface by using a printer driver installed in a host device that can bilaterally communicate with a printer will now be described in greater detail with reference to FIG. 5.

FIG. 5 is a flowchart of a method of forming a user interface according to another embodiment of the present general inventive concept. Referring to FIG. 5, in operation S10, a host device issues (outputs) a request for user interface information to a printer. Here, the user interface information includes a list of functions supported by the printer. In operation S12, the host device receives the user interface information from the printer. In operation S14, the host device forms a user interface by using the user interface information received from the printer.

The user interface information received from the printer may be stored in a memory of the host device, so the host device does not need to receive the user interface information again from the printer. Alternatively, when the host device selects the printer later again, it may receive the user interface information from the printer.

The user interface may be displayed on a screen of a monitor so that a user can select one or more of the functions supported by the printer 2 that the user desires to use via the user interface. In addition, the selected functions are stored in the memory, so the user does not need to select the corresponding functions again later.

The functions supported by the printer 2 may include at least one of a function associated with types of printing papers supported by the printer 2 and a function associated with resolutions supported by the printer 2. The user interface information includes printer control commands respectively associated with the functions supported by the printer 2.

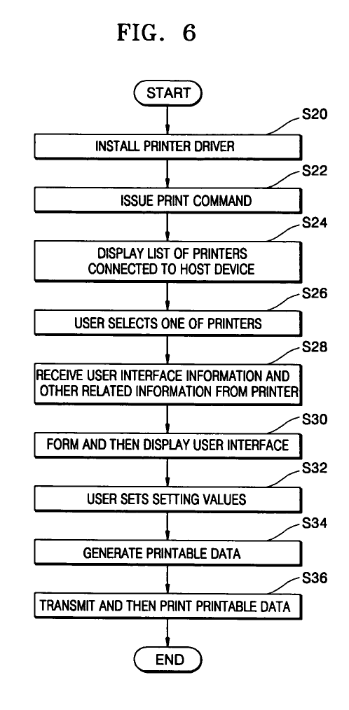

FIG. 6 is a flowchart of a printing method using a printer driver according to another embodiment of the present general inventive concept. Referring to FIG. 6, in operation S20, the printer driver is installed in a host device. In operation S22, a user forms a document by executing an application program and then issues a print command. In operation S24, the host device displays a list of printers connected thereto on a screen of a monitor. In operation S26, the user selects one of the printers with which the document is to be printed. In operation S28, a printer data acquisition unit (28 of FIG. 2) of the printer driver receives user interface information and other related information from the selected printer in real time. Here, the user interface information includes a list of functions supported by the selected printer, such as types of printing papers and resolutions supported by the selected printer, and the related information includes user interface manufacture information, which is necessary to form a user interface, and printer control commands respectively associated with the functions supported by the printer 2.

In operation S30, a GUI generator (24 of FIG. 2) of the printer driver forms the user interface using the user interface information and the related information and displays the user interface on the screen of the monitor. In operation S32, the user sets setting values respectively associated with the functions supported by the printer 2 by using the user interface displayed on the screen of the monitor.

In operation S34, the printer driver generates printable data by associating the document with printer control commands respectively corresponding to the selected functions. In operation S36, the printable data is transmitted to the selected printer and then printed out.

As described above, according to the present general inventive concept, it is possible to drive a plurality of printers by installing only one printer driver in a host device and forming a user interface based on user interface information received from each of the printers. Therefore, a user does not need to install as many printer drivers in the host device as there are printers. In addition, printer manufactures do not need to develop different printer drivers for different types of printers that they manufacture.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of a printer driver installed in a host device that bilaterally communicates with a printer, the method comprising:
outputting a request for user interface information to a printer;
receiving the user interface information including one or more functions supported by the printer from the printer; and
forming a user interface using the user interface information received from the printer.

2. The method of claim 1, further comprising:
storing the user interface information received from the printer in a memory of the host device.

3. The method of claim 1, further comprising:
displaying the user interface on a screen of a monitor.

4. The method of claim 3, further comprising:
enabling a user to select at least one of the one or more functions supported by the printer via the user interface displayed on the screen of the monitor.

5. The method of claim 4, further comprising:
storing the selected one or more functions in a memory of the host device.

6. The method of claim 1, wherein the receiving of the user interface information comprises:
receiving the one or more functions including at least one of a function associated with types of printing papers supported by the printer, a function associated with a printing direction supported by the printer, and a function associated with resolutions supported by the printer.

7. The method of claim 1, wherein the receiving of the user interface information comprises:
receiving printer control commands respectively associated with the one or more functions supported by the printer.

8. The method of claim 1, wherein the receiving of the user interface information from the printer comprises receiving the user interface information from the printer in real time when the request for user interface information is transmitted to the printer.

9. A printer driver installed in a host device that bilaterally communicates with a printer, the printer driver comprising:
a printer data acquisition unit which outputs a request for user interface information to the printer and receives the user interface information from the printer, the user interface information including one or more functions supported by the printer; and
a user interface manager which forms a user interface using the user interface information received from the printer.

10. The printer driver of claim 9, wherein the host device comprises a memory, and the printer data acquisition unit stores the user interface information received from the printer in the memory of the host device.

11. The printer driver of claim 9, wherein the host device comprises a monitor, and the user interface manager displays the user interface on a screen of the monitor.

12. The printer driver of claim 11, wherein the user interface manager comprises a user selection processor which processes at least one of the one or more functions selected via the user interface displayed on the screen of the monitor.

13. The printer driver of claim 12, wherein upon receiving a request for printing a document, the user selection processor transmits printer control commands respectively corresponding to the selected one or more functions to the printer together with the document.

14. The printer driver of claim 12, wherein the host device comprises a memory, and the user interface manager stores the selected one or more functions in the memory of the host device.

15. The printer driver of claim 9, wherein the one or more functions supported by the printer comprise at least one of a function associated with types of printing papers supported by the printer, a function associated with a printing direction supported by the printer, and a function associated with resolutions supported by the printer.

16. The printer driver of claim 9, wherein the user interface information comprises printer control commands respectively associated with the one or more functions supported by the printer.

17. The printer driver of claim 9, wherein the user interface manager comprises a graphic user interface (GUI) generator which forms the user interface in a GUI form using the user interface information received from the printer.

18. The printer driver of claim 9, wherein the printer data acquisition unit receives the user interface information from the printer in real time when the request is transmitted to the printer.

19. A printer driver installed in a host device that bilaterally communicates with a first and a second printers, the printer driver comprising:
a printer data acquisition unit which outputs a first request for first user interface information to a first printer and a second request for second user interface information to a second printer, and receives from the first and second printers the first and second user interface information including one or more first functions and one or more second functions supported by the first and second printers, respectively; and
a user interface manager which forms a first user interface and a second user interface using the first and second user interface information received from the first and second printers, respectively.

20. The printer driver of claim 19, wherein the printer driver is a single printer driver installed in the host device connected to the first and second printers to form the first a first user interface and the second user interface and to communicates with the first and second printers.

21. The printer driver of claim 19, wherein the first user interface information comprises first printer control commands to control the first printer, and the second user interface information comprises second printer control commands to control the second printer.

22. The printer driver of claim 19, wherein the host device comprises a monitor, and the user interface manager generates a display signal to the monitor to display the first user interface and the second user interface on a screen of the monitor.

23. The printer driver of claim 19, wherein the printer data acquisition unit receives the first user interface information from the first printer and the second user interface information from the second printer in real time when the first request and the second request are transmitted to the first printer and the second printer, respectively.

24. A method of a printer driver installed in a host device that bilaterally communicates with a first and a second printers, the method comprising:
outputting a first request for first user interface information to a first printer and a second request for second user interface information to a second printer;
receiving from the first and second printers the first and second user interface information including one or more first functions and one or more second functions supported by the first and second printers, respectively; and
forming a first user interface and a second user interface using the first and second user interface information received from the first and second printers, respectively.
